(19) United States
(12) Patent Application Publication
(10) Pub. No.: US 2026/0094265 A1
(43) Pub. Date: Apr. 2, 2026

(54) A COMPUTER-IMPLEMENTED, GRAPH-BASED METHOD OF ANALYSING AN IMAGE OF A TISSUE SPECIMEN

(71) Applicant: THE UNIVERSITY OF WARWICK, Coventry (GB)

(72) Inventors: Nasir RAJPOOT, Coventry (GB); David SNEAD, Coventry (GB); Fayyaz MINHAS, Coventry (GB); Simon GRAHAM, Coventry (GB)

(21) Appl. No.: 19/109,928

(22) PCT Filed: Sep. 8, 2023
(86) PCT No.: PCT/GB2023/052340

§ 371 Date: Mar. 7, 2025

(30) Foreign Application Priority Data
Sep. 9, 2022 (GB) 2213199.9

(51) Int. Cl. G06T 7/00; G06T 7/62; G06V 10/44; G06V 10/82; G06V 10/86

(52) U.S. Cl. CPC G06T 7/0012; G06T 7/62; G06V 10/44; G06V 10/82; G06V 10/86; G06T 2207/10056; G06T 2207/20072; G06T 2207/20084; G06T 2207/30024; G06T 2207/30096; G06T 2207/30242; G06V 2201/03

(57) ABSTRACT

A computer-implemented method is provided of analysing an image of a tissue specimen, which method comprises steps including detecting in the image each of a primary type of biological entity, detecting in the image one or more secondary types of biological entity, associated with each of the detected primary biological entities, generating an entity graph, in which each graph node is assigned to a primary biological entity, and in which each graph node is associated with predictive features measured from the image in respect of that graph node, including at least one predictive feature that is measured relative to two or more types of biological entity.

The present invention relates to a computer-implemented method of analysing an image of a tissue specimen, and more specifically to a method of determining abnormalities within a whole slide image of a tissue specimen.

Frequently, doctors perform biopsies, for example during a colonoscopy, in which they remove small tissue samples, eg from the colon, and send them to a laboratory for analysis. The tissue samples are analysed for the presence of infections or cancerous cells and signs of inflammation, to enable doctors to diagnose illnesses, such as Crohn's disease, ulcerative colitis, as well as cancer.

During the colonic analysis, for example, a series of known histological features, such as gland architecture and inflammatory cell density, are assessed for signs of abnormality. Histological examination is a vital component in ensuring accurate diagnosis and appropriate treatment of many diseases. It enables microscopic assessment of key patterns in the tissue, which is a major step in understanding the state of various conditions, such as cancer. Histopathology has been at the forefront of many advances in care including cancer screening programmes, molecular pathology, tumour classification and companion diagnostic testing, resulting in a rapid rise in demand for histology-derived data.

Around a third of endoscopic colon biopsies carried out across the world result in the colon being reported as normal, and the patient therefore requires minimal intervention. However, pathologists are still required to analyse each sample that is taken, which places unnecessary burden on already overloaded pathology departments. This undue burden may ultimately lead to delays in diagnosis, negatively impacting patient care, especially for those with diseases where early treatment is crucial.

During the examination process, the pathologist examines each biopsy slide searching for disease, typically working from low magnification to high magnification, and analyses a set of pre-defined histological features, such as gland architecture, inflammation and nuclear atypia for signs of abnormality. The resulting report indicates the presence of any disease process and categorises the abnormality into the most appropriate diagnosis.

More recently it has been suggested that automated (machine derived) recognition of “normal” samples may prove to be useful in helping to address rising histopathology capacity problems, i.e. by filtering out “normal” samples so that they do not have to be assessed by a pathologists. Indeed, since the advent of digital pathology, there has been a sharp increase in the development of artificial intelligence (AI) tools that enable automatic analysis of multi-gigapixel whole-slide images (WSIs). In particular, deep learning (DL) algorithms have achieved good performance in tasks including cancer grading and survival analysis.

Such models can be leveraged to help reduce inevitable errors in diagnosis, given that humans are naturally prone to mistakes, whereas AI tools are not as susceptible to such errors. However, distinguishing normal tissue samples from abnormal tissue samples using these techniques remains a challenge, due to the difficulty in detecting various subtle conditions, such as mild inflammation.

It is believed that this is because existing methods work with image regions/visual fields (as square patches), and therefore fail to explicitly model both the tissue micro-structure and macro-structure, encompassing glandular architecture, inflammatory cell density and the relationship between inflammatory cells, glandular structures and the epithelium. Hence, relying solely on DL models to detect these histological patterns, which are known to be relevant, in small image regions may lead to sub-optimal performance.

Graph neural networks (GNNs) have also recently become popularised in Computational Pathology (CPath). Graphs used as the input to these models comprise of a collection of nodes, each with an associated set of features, and edges that encode the inter-node relationships. These nodes are positioned at defined positions in the tissue, and therefore provide flexibility in the way that features are represented across the WSI. However, existing methods usually consider fixed-size image patches at each node, and therefore fail to incorporate features derived from macrostructures, which can span multiple image patches.

Furthermore, although several methods position nodes at known histological entities, DL-based features are commonly used, again contributing to significantly reduced interpretability. Rather than using features derived from image regions, graphs have previously been built on nuclei (also known as cell-graphs) with associated morphological features. However, nuclei are the most basic building block in the tissue and therefore associated features may have limited expressive power, where they fail to model important multi-cellular structures, such as glands. Cell-graphs can also be very large, where a single tissue sample can contain tens of thousands of nuclei, leading to the generation of intractable graph models.

Perhaps most importantly, the output of these methods typically provides no explanation as to how/why a sample is deemed to be normal or abnormal, thus providing a pathologist with no means of confirming the correctness of the determination, or explaining the reasoning behind the determination, which could in turn help to boost the pathologist confidence in the determination and help the clinicians decide the appropriate course of action. An explainable approach would therefore be preferable because the user can ensure algorithmic fairness, identify potential bias in training data and confirm that the algorithms are performing as expected.

There has now been devised an improved a method of determining abnormalities within a tissue sample which overcomes or substantially mitigate some or all of the aforementioned disadvantages associated with the prior art.

According to a first aspect of the invention, there is provided a computer-implemented method of analysing an image of a tissue specimen, which method comprises steps of:
(a) detecting in the image each of a primary type of biological entity;
(b) detecting in the image one or more secondary types of biological entity, associated with each of the detected primary biological entities;
(c) generating an entity graph for the image, in which each graph node is assigned to a primary biological entity, and in which each graph node is associated with predictive features measured from the image in respect of that graph node, including at least one predictive feature that is measured relative to two or more types of biological entity;
(d) inputting the entity graph into one or more machine learning algorithms to compute one or more predictions for the tissue specimen;
(e) outputting the one or more predictions.

The method according to the first aspect of the invention may be advantageous in that the use of an entity graph, with nodes assigned to a primary biological entity, associated with features measured from the image in respect of that graph node, including at least one feature that is measured relative to two or more types of biological entity, enables the use of predictive features that are more clinically relevant than in the prior art. This may provide an improved prediction for the tissue specimen and may enable improved outputs for clinicians, for example including clinically meaningful information regarding the prediction.

The image of the tissue specimen may be obtained by conventional means known in the field of digital pathology and may be a result of a biopsy, resection or another method of tissue extraction, for example. The image or a tissue specimen may be a microscopy image, which may be digitised. The image may be a so-called “whole-slide image” (WSI) of a tissue specimen, which may be generated by combining images that are captured at different magnification levels. The image may contain a plurality of discrete tissue regions.

The method steps (a) to (d) may be repeated for each of a plurality of images before predictions are output to the user.

The method may be performed in respect of a plurality of images and/or a plurality of tissue specimens at each step. For example, the entity graph may be generated for a plurality of images and/or for a plurality of tissue specimens, before the entity graph is input into one or more machine learning algorithms to compute one or more predictions for the tissue specimen.

The detection of the biological entities in the method may include segmentation of those biological entities. The segmentation may include delineating object boundaries, categorising types of biological entities, and distinguishing between different variations of a biological entity.

The primary type of biological entity may have a different size relative to the one or more secondary types of biological entity, eg a different average size. The primary type of biological entity may have a greater size, eg greater average size, relative to the one or more secondary types of biological entity. A plurality of secondary biological entities may be contained within each primary biological entity. The entity graph generated may therefore be considered to be a multi-scale entity graph, as the primary type of biological entity and the secondary type of biological entity may be at different scales.

The primary type of biological entity may be a clinically-relevant grouping of cells, and in particular may be glands. The primary type of biological entity may include more than one types of biological entity, and may include other clinically-relevant tissue regions. Each node may be assigned to a single biological entity of the primary type. The one or more secondary types of biological entity may be nuclei and/or lumen within the associated gland. The method may therefore comprise generating an entity graph, in which each graph node is assigned to a gland, and in which each graph node is associated with predictive features measured from the image in respect of that graph node, including at least one predictive feature that is measured relative to two or more types of biological entity, for example selected from glands, nuclei and lumen.

An entity graph may comprise nodes that represent respective biological entities detected, interconnected by edges representing interactions between entities represented by the nodes.

Mathematically, a graph may be defined as G≡(V, E), where V is a set of N vertices (or nodes) and E is a set of edges, where ei,j∈E denotes an edge between nodes i and j∈V. V describes the set of all glands in a whole slide image, with each node corresponding to a discrete gland. Each node may have an associated k-dimensional feature vector xᵢ for i∈V. For example, an edge e_{i,j} may be determined if the Euclidean distance between the centroids of two nodes is less than a certain threshold. Since entities such as glands can often be non-convex, especially when they become cancerous, the method may define an edge e_{i,j} in the graph if the minimum distance between points on the boundary contours of two glands is less than a certain distance α.

Where the image contains a plurality of separate tissue regions on the slide, and there is no biological significance for how these are arranged, the nodes are not connected between neighbouring tissue regions. Thus, in addition to the criteria defined above, the method may also ensure that an edge e_{i,j} only exists if both i and j are located within the same tissue region.

Each graph node is associated with predictive features measured from the image in respect of that graph node, including at least one predictive feature that is measured relative to two or more types of biological entity. Each graph node may be associated with at least one, at least 5, at least 10, at least 15 or at least 20 predictive features. There may be a plurality of predictive features that are measured relative to two or more types of biological entity, and each graph node may be associated with at least one, at least 5, at least 10, at least 15 or at least 20 of these predictive features that are measured relative to two or more types of biological entity.

The predictive features are pre-defined measurements of the biological entities and are capable of identifying various histological conditions, either in isolation or in combination with other predictive features. Where the primary type of biological feature is a gland, the predictive features may be gland, intra-gland and/or inter-gland features.

The predictive features may be determined with respect to parts of the biological entities, including centroids and boundaries. The predictive features may be any or any combination of a linear dimension of a biological entity, an area of a biological entity, a morphological measure of a biological entity, a count of a biological entity, e.g. within another biological entity, a linear separation between biological entities, e.g. between centroids, boundaries or a combination thereof.

The predictive features may be a statistical measure of a plurality of measurements. The statistical measure may relate to an average, e.g. a mean, or a variation, e.g. a standard deviation. The dimensions and areas may be measured in pixels, at a known distance per pixel. The measurement may be normalised, e.g. by the size of the primary biological entity (e.g. the gland).

The morphological measure of a biological entity may be a measure of ellipticity, e.g. to facilitate identification of abnormal biological entities, e.g. glands, with irregular shapes.

The features measured may be any one or more of the features listed in Table 1.

The entity graph is inputted into one or more machine learning algorithms to compute one or more predictions for the tissue specimen, and the one or more machine learning algorithms may include a graph neural network.

The one or more predictions may be indicative of whether the tissue specimen, or part of the tissue specimen, falls within a particular category. This categorisation may be clinically derived. For example, the one or more predictions may be indicative of whether the tissue specimen is normal or abnormal. Alternatively, the prediction may be more specific, for example being indicative of a particular diagnosis.

The entity graph may be a representation G≡(V, E) in terms of its nodes V and their non-directional edges E, and the entity graph may be passed through a graph neural network (GNN) to compute a prediction score for the tissue specimen, eg indicative of whether the tissue is normal or abnormal. Each node vector, xᵢ, of the entity graph may represents a primary biological entity, e.g. a gland, in terms of the predictive features, and the GNN may aggregate information across nodes using the edges in its computation.

The number of nodes and edges in each graph may be different depending upon the tissue structure or the prediction task or both.

The graph neural network may comprise an aggregation step, for example by updating each node representation by aggregating information from its neighbours.

A softmax function may also be applied, and the trainable weights in the graph neural network may be optimised end-to-end, for instance by minimising the binary cross entropy loss between the output and the ground truth values of training examples, i.e. as a method of calibration.

The method may use a real-valued mask, which gives less weight to unimportant graph components. In particular, a subset of nodes and features may be generated that play a greater role in the graph neural network's prediction, and nodes and features of the GNN that are of lesser importance may be removed, as they should have a negligible impact on the output prediction.

The method may use a node explanation mask and a feature explanation mask that are learned. Rather than applying a threshold to the learned masks to give a compact subgraph, the method may instead visualise the raw mask output, which provides an interpretable and explainable output that can be understood and explained by researchers and clinicians. Specifically, the node explanation mask can be overlaid on top of the glands within the whole slide image in the form of, for example, a heat map.

The output of the method may include an identification of the biological entities that contribute to the prediction. The output may also include an indication of the strength of the contribution to the prediction. This output may be presented as an image, e.g. in the form of a heat map.

The output of the method may also include an identification of the feature or features for a particular node that contribute to the prediction. The identification of the feature or features that contribute to the prediction may be displayed for one or more nodes that most strongly contribute to the prediction. The output may also include an indication of the strength of the contribution of the feature or features to the prediction. This output may be presented numerically or as a chart, for example.

The feature or features that are identified may be accompanied by a description of the clinical relevance of the feature or features, thereby assisting the user n formulating a diagnosis or quantification of biologically or clinically interpretable measurements of tissue contents or both.

According to a further aspect of the invention, there is provided a data processing apparatus comprising a processor configured to perform the method defined above.

According to a further aspect of the invention, there is provided a computer program comprising instructions which, when the program is executed by a computer, cause the computer to carry out the method defined above.

A computer-readable data carrier having stored thereon the computer program defined above.

Practicable embodiments of the invention will now be described, by way of example only, with reference to the accompanying drawings, of which:

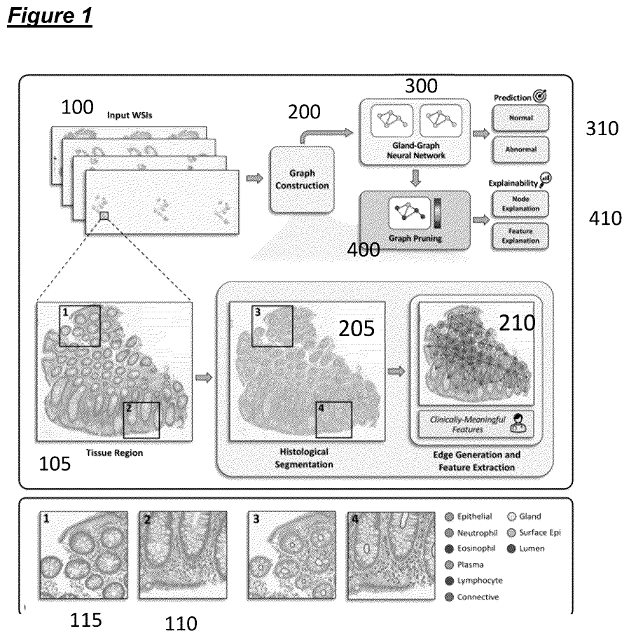

FIG. 1 is a flowchart illustrating a method of analysing whole slide images according to a first embodiment of the invention;

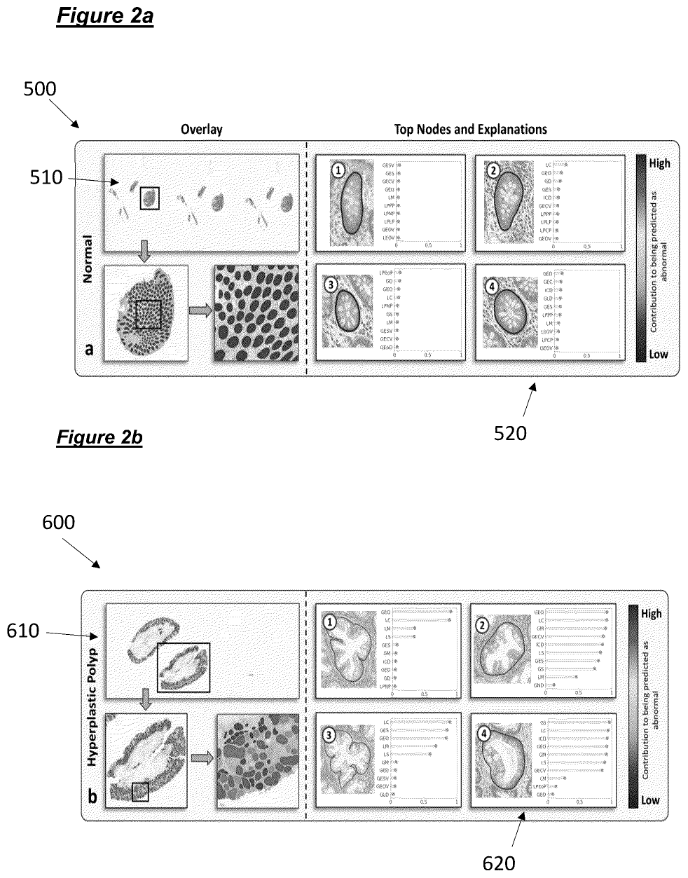

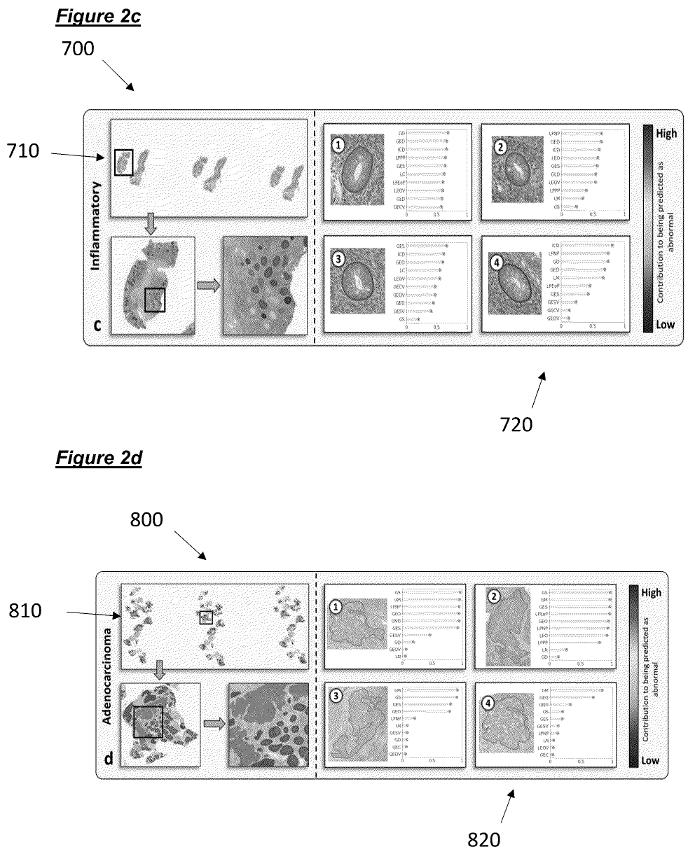

FIG. 2A is an example graphical user interface presented to an operator as a result of the analysis conducted using the method of FIG. 1, where the glands depicted in the whole slide image are normal;

FIG. 2B is an example graphical user interface presented to an operator as a result of the analysis conducted using the method of FIG. 1, where the glands depicted in the whole slide image are hyperplastic;

FIG. 2C is an example graphical user interface presented to an operator as a result of the analysis conducted using the method of FIG. 1, where the glands depicted in the whole slide image are inflammatory;

FIG. 2D is an example graphical user interface presented to an operator as a result of the analysis conducted using the method of FIG. 1, where the glands depicted in the whole slide image are cancerous;

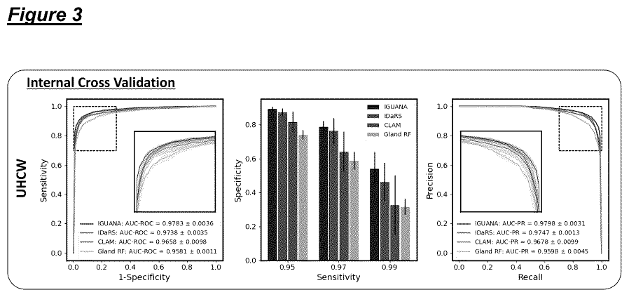

FIG. 3 is a series of graphical representations of an internal cross-validation of the method of FIG. 1 versus alternative methods known in the state of the art;

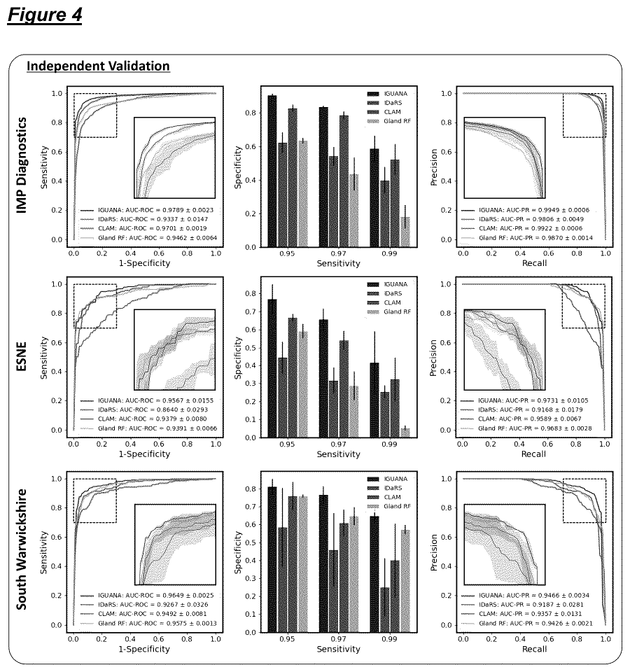

FIG. 4 is a series of graphical representations of an external validation of the method of FIG. 1 versus alternative methods known in the state of the art; and

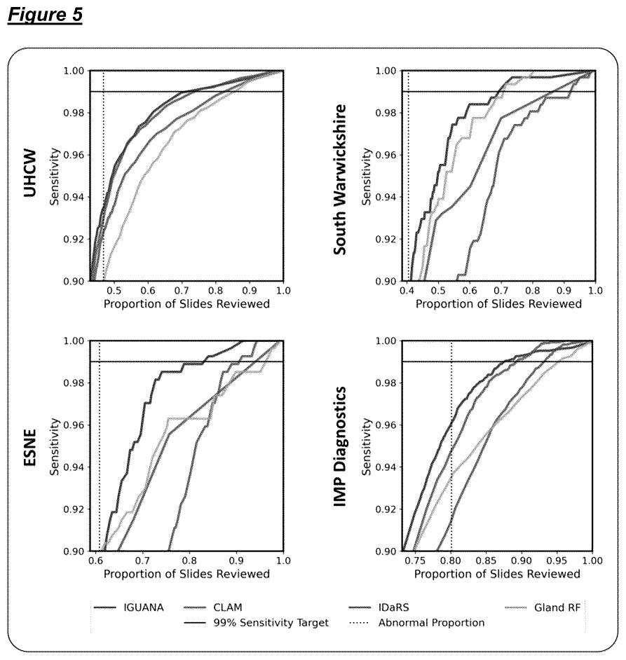

FIG. 5 is a series of graphical representations of the potential effect of the method of FIG. 1 on the efficiency of clinical practice versus alternative methods known in the state of the art.

FIG. 1 illustrates a method of analysing whole slide images, and the various steps illustrated in FIG. 1 are explained at a more detailed level in relation to the other Figures.

At step 100, unedited whole slide images are prepared and input into the system. Examples of magnified portions of whole slide images are illustrated in parts 105, 110 and 115 of FIG. 1.

At step 200, a graph is constructed based on the whole slide image inputted at step 100. The generation of the graph, herein referred to as a gland-graph, consists of steps 205 and 210.

At step 205, various objects depicted within the tissue of the whole slide image are segmented. In particular, nuclei, glands, lumen and different tissue regions within the image are segmented. As well as delineating object boundaries, this step determines the category of each nucleus and differentiates the surface epithelium from other glands. This may be implemented by existing methods or software, such as that described in Graham, S., et al., One Model is All You Need: Multi-Task Learning Enables Simultaneous Histology Image Segmentation and Classification, arXiv preprint arXiv: 2203.00077 (2022).

Mathematically, a graph is defined as G≡(V, E), where V is a set of N vertices (or nodes) and E is a set of edges, where e_{i,j}∈E denotes an edge between nodes i and j∈V. In this case, V describes the set of all glands in a whole slide image. Each node typically has an associated k-dimensional feature vector xᵢ for i∈V. In many approaches an edge e_{i,j} is considered if the Euclidean distance between the centroids of two nodes is less than a certain threshold. The distance between neighbouring node centroids is suitable for convex node entities, such as nuclei, because centroids will usually be located within the object. However, glands can often be non-convex, especially when they become cancerous. Therefore, the method instead defines an edge e_{i,j} in the gland-graph if the minimum distance between points on the boundary contours of two glands is less than a certain distance α.

As opposed to surgical resection samples, which usually contain a large bulk of tissue, biopsies can contain many separate tissue regions on the slide. Thus, in addition to the criteria defined above, the method also ensures that an edge ei,j only exists if both i and j are located within the same tissue region.

After performing segmentation of the various histological objects, at step 210, the method measures a set of clinically meaningful features from the segmented images. Those features have been chosen based on the features that are conventionally used in current methodology (i.e. the manual method performed by pathologists currently).

In particular, because glands, lumen and nuclei have been segmented in step 205, interesting gland, intra-gland and inter-gland features are identified in step 210 that are potentially capable of identifying various histological conditions. Examples of these features are given in Table 1 below, along with the conditions of which they may be indicative.

TABLE 1

| | | Histological | Main Conditions |
|---|---|---|---|
| Feature Name | Feature Description | Description | Modelled |
| Gland size | Size of gland (number of pixels at | Gland | Neoplasia, dysplasia, |
| | 0.5 microns/pixel) | enlargement | adenomatous polyps |
| Gland morphology | How far gland is from being | Gland | Neoplasia, dysplasia. |
| | elliptical - BAM distance³⁸ | distortion, | adenomatous polyps |
| | | gland | |
| | | branching | |
| Gland density | Distance to nearest gland | Gland dropout | Inflammation |
| Lumen size | Size of lumen (number of pixels at | Lumen | Neoplasia, dysplasia, |
| | 0.5 microns/pixel) | dilation | hyperplastic polyps |
| Lumen | How far lumen is from being | Lumen | Hyperplastic polyps |
| morphology | elliptical - BAM distance³⁸ | serrations | |
| Lumen number | Lumen count within gland | Cribriform | Neoplasia |
| | | architecture | |
| Lumen | Ratio of lumen to gland area | Gland dilation | Hyperplasia |
| composition | | | |
| Gland epithelial | Average size of epithelial nuclei | Epithelial cell | Neoplasia, dysplasia, |
| size | within a gland | atypia | adenomatous polyps |
| Gland epithelial | Standard deviation of epithelial | Epithelial cell | Neoplasia, dysplasia, |
| size variation | nuclei size within a gland | atypia | adenomatous polyps |
| Gland epithelial | Average distance of intra-gland | Stratification of | Neoplasia, dysplasia, |
| organisation | epithelial nuclei to nearest gland | epithelial cells | adenomatous polyps |
| | boundary | | |
| Gland epithelial | Standard deviation of intra-gland | Uneven | Neoplasia, dysplasia, |
| organisation | epithelial nuclei distances to | stratification of | adenomatous polyps |
| variation | nearest gland boundary | epithelial cells | |
| Gland epithelial | Average distance between intra- | Epithelial cells | Neoplasia, dysplasia, |
| clustering | gland epithelial nuclei | tightly packed | adenomatous polyps |
| Gland epithelial | Standard deviation of intra-gland | Epithelial cells | Neoplasia, dysplasia, |
| clustering variation | epithelial nuclei distances to | unevenly | adenomatous polyps |
| | nearest gland boundary | spaced | |
| Lumen epithelial | Average distance of intra-gland | Gland dilation, | Neoplasia, dysplasia, |
| organisation | epithelial nuclei to nearest lumen | cribriform | hyperplastic polyps |
| | boundary | architecture | |
| Lumen epithelial | Standard deviation of intra-gland | Lumen | Neoplasia, dysplasia, |
| organisation | epithelial nuclei distances to | serrations, | hyperplastic polyps |
| variation | nearest lumen boundary | cribriform | |
| | | architecture | |
| Gland epithelial | Number of intra-gland epithelial | Solid sheets of | Neoplasia, dysplasia, |
| density | nuclei, normalised by the gland | epithelial cells | adenomatous polyps |
| | size | | |
| Gland lymphocyte | Number of intra-gland | Gland | Inflammation |
| density | lymphocytes, normalised by the | lymphocyte | |
| | gland size | infiltration | |
| Gland neutrophil | Number of intra-gland neutrophils, | Gland | Inflammation |
| density | normalised by the gland size | neutrophil | |
| | | infiltration | |
| | | (crypt | |
| | | abscess) | |
| Gland eosinophil | Number of intra-gland | Gland | Inflammation |
| density | eosinophils, normalised by the | eosinophil | |
| | gland size | infiltration | |
| LP lymphocyte | Proportion of lymphocytes within | Lymphocytic | Inflammation |
| proportion | nearest 220 nuclei to gland | colitis | |
| LP plasma cell | Proportion of plasma cells within | Colitis | Inflammation |
| proportion | nearest 220 nuclei to gland | | |
| LP neutrophil | Proportion of neutrophils within | Acute | Inflammation |
| proportion | nearest 220 nuclei to gland | inflammation | |
| LP eosinophil | Proportion of eosinophils within | Eosinophilic | Inflammation |
| proportion | nearest 220 nuclei to gland | colitis | |
| LP connective | Proportion of connective tissue | Desmoplasia | Inflammation |
| tissue cell | cells within nearest 220 nuclei to | | |
| proportion | gland | | |
| LP inflammatory | Mean distance of nearest 250 | General | Inflammation, |
| cell density | inflammatory nuclei to gland | inflammation | hyperplastic polyps |

The various features described in the above table may be measured or quantified using conventional methods known in the art. For example, to quantify the epithelial organisation, the method may compute the mean and standard deviation of distances of epithelial nuclei centroids to their nearest gland boundary. In another example, to quantify the morphology of glands, the method may utilise the best alignment metric described in Awan, R., et al., Glandular morphometrics for objective grading of colorectal adenocarcinoma histology images, Scientific reports 7, 1-12 (2017), which provides a measure of how elliptical an object is, to help capture abnormal glands with irregular shapes.

At step 300, having formed a gland-graph representation G≡(V, E) in terms of its nodes V and their non-directional edges E in step 200, the analysed version of the whole slide image is passed through a graph neural network (GNN) to compute a prediction score indicative of whether the tissue is normal or abnormal. Each node vector, xᵢ, represents a gland in terms of the previously described features, and the GNN aggregates information across nodes using the edges in its computation. Note that the number of nodes and edges in each graph can be different depending upon the tissue structure.

The GNN first applies a linear operation on xᵢ∈ [symbol] ²⁵ to produce another node level feature representation h⁰ᵢ for input into two Principal Neighbourhood Aggregation (PNA) graph convolution layers, as described in Corso, G., Cavalleri, L., Beaini, D., Liò, P. & Veličković, P. Principal neighbourhood aggregation for graph nets. Advances in Neural Information Processing Systems 33, 13260-13271 (2020). Each PNA layer (l=1,2) updates each node representation by aggregating information from its neighbours j E Ni according to the following rule:

$${h}_{i}^{l} = {γ}_{l} ( {h}_{i}^{l - 1} , {ρ}_{l} ( {h}_{i}^{l - 1} , {h}_{j}^{l - 1} ) ) \qquad [ 1 ]$$

where γₗ and ρₗ are multi-layer perceptrons (MLPs) each with their own trainable weights. The outputs of the two PNA layers are then concatenated and fused with a linear operation to arrive at the final node-level feature embedding rᵢ. Finally, the output f(G)∈ [symbol] ^{c} is obtained by performing attention-based global pooling, as follows:

$$f ( G ) = {\sum }_{i = 1}^{N} \frac{exp ( ψ ( {r}_{i} ) )}{{\sum }_{j = 1}^{N} exp ( ψ ( {r}_{j} ) )} ⊙ ω ( {r}_{i} ) \qquad [ 2 ]$$

where ψ and ω are MLPs and C is the number of classes predicted by the network. ⊙ denotes element-wise multiplication and hence the global pooling operator learns to assign a varying weight to different gland representations, signifying their relative importance in the final prediction. Finally, a softmax function is applied and all the trainable weights in the GNN are optimised end-to-end by minimising the binary cross entropy loss between the output and the ground truth values of training examples, i.e. as a method of calibration.

In step 400, a graph pruning approach is taken, for example using the method disclosed in Ying, Z., Bourgeois, D., You, J., Zitnik, M. & Leskovec, J. Gnnexplainer: Generating explanations for graph neural networks. Advances in neural information processing systems 32 (2019).

The described method provides optimisation that maximises the mutual information between a GNN's prediction and the distribution of possible subgraph structures. Practically, this is achieved by learning a real-valued mask, which gives less weight to unimportant graph components. This enables the generation of a subset of nodes and features that play a crucial role in the GNN's prediction of abnormality, whilst removing unimportant nodes and features of the GNN, because they should have a negligible impact on the output abnormality prediction.

In the illustrated method, a node explanation mask Mₙ∈ [symbol] ^{N} and a feature explanation mask M_{f}∈ [symbol] ^{N×25} are learned, where N denotes the number of nodes in each whole slide image, and 25 is the pre-defined number of features, as per the above table. Rather than applying a threshold to the learned masks to give a compact subgraph, the method instead visualises the raw mask output in step 410, which provides an interpretable and explainable output that can be understood and explained by researchers and clinicians.

Specifically, the learned mask Mₙ provides the node explanation which can be overlaid on top of the glands within the whole slide image in the form of, for example, a heat map, as illustrated in FIGS. 2A-2D.

FIGS. 2A-2D illustrate a graphical user interface 500, 600, 700, 800 that could be presented to clinicians for use in analysing the whole image slides. The graphical user interface 500, 600, 700, 800 includes a copy of the whole slide image 510, 610, 710, 810 with an overlaying heat map that indicates the likelihood of abnormality associated with each gland.

The graphical user interface 500, 600, 700, 800 also includes cropped images 520, 620, 720, 820 of each of the most predictive nodes within the whole slide image, i.e. those nodes that have been highlighted as most strongly contributing to the prediction of abnormality. Next to each of these cropped images is a list of the ten most predictive features in descending order of significance, as per the above table, and a feature importance value between 0 and 1. The display of the feature importance value represents those features most strongly contributing to the heat map, and how strongly they are contributing, where 0 represents a weak contribution and 1 represents a strong contribution.

FIG. 2A illustrates an example slide in which the glands are deemed to be normal, and hence are highlighted in dark blue in the whole slide image 510. Four cropped images 520 of the most predictive nodes have been provided, although it can be seen that for each of the ten “most” predictive features, the feature importance value is a low one, thus indicating that the predictive features suggest the glands are normal. Thus, no action is required by the clinician. Nonetheless, the ten most predictive features are still shown for each cropped image 520, so that the clinician can easily check those features against the image itself, i.e. to confirm the correctness of the output of the method.

FIG. 2B illustrates an example slide in which the glands are deemed to be hyperplastic, and hence portions of the slide are highlighted in dark red in the whole slide image 610. Hyperplastic polyps are often characterised by intraluminal folds and lumen dilation. In particular, it can be seen that the most predictive glands within FIG. 2B, displayed as cropped images 620-1, 620-2, 620-3 and 620-4, contain lumen with a clearly irregular morphology. In particular, for cropped image 620-1 and 620-2, it is output that the most predictive feature is gland epithelial organisation (GEO), for cropped image 620-3 it is output that the most predictive feature is lumen composition (LC), and for cropped image 620-4, it is output that the most predictive feature is gland size (GS). Thus, the clinician is informed that these features are key to the determination of these whole slide images being deemed to be abnormal.

FIG. 2C illustrates an example slide in which the glands are deemed to be inflammatory, and hence portions of the slide are highlighted in dark red in the whole slide image 710. Inflammatory conditions usually have an increased number of lymphocytes, plasma cells, eosinophils and neutrophils within the lamina propria and potentially within the glands. Other indicators of inflammation can include crypt branching and crypt dropout. Colon adenocarcinoma is often denoted by irregular glandular morphology, epithelial nuclear atypia and multiple lumina. Four cropped images 720-1, 720-2, 720-3, 720-4 of the most predictive nodes have been provided. For cropped image 720-1, it is output that the most predictive feature is gland density (GD). For cropped image 720-2, it is output that the most predictive feature is LP neutrophil proportion (LPNP). For cropped image 720-3, it is output that the most predictive feature is gland epithelial size (GES). For cropped image 720-4, it is output that the most predictive feature is LP inflammatory cell density (ICD). Thus, the clinician is informed that these features are key to the determination of these whole slide images being deemed to be abnormal.

FIG. 2D illustrates an example slide in which the glands are deemed to be cancerous, and hence portions of the slide are highlighted in dark red in the whole slide image 810. High-grade cancers typically lose their glandular appearance and instead form solid sheets of tumour cells. It can be seen from the heat map in FIG. 2D that there are areas that have lost their conventional glandular appearance. Specifically, epithelial nuclei are no longer arranged at the gland boundary, cribriform architecture is observed, and glands appear much larger, due to the formation of tumour cell sheets. Four cropped images 820-1, 820-2, 820-3, 820-4 of the most predictive nodes have been provided. For cropped images 820-1 and 820-2, it is output that the most predictive feature is in gland size (GS). For cropped image 820-3, it is output that the most predictive feature is gland morphology (GM). For cropped image 820-4, it is output that the most predictive feature is gland morphology (GM). Thus, the clinician is informed that these features are key to the determination of these whole slide images being deemed to be abnormal.

It can be seen that the glands of images 820 are all large, have irregular morphology and often display solid sheets of tumour cells with no obvious glandular structure. This is highlighted in the feature explanation, where gland morphology, gland size and epithelial organisation are consistently top-ranked predictive features.

Since the above-described method is intended to replace pathologist evaluation at an early stage, i.e. to filter out normal samples that do not need to be assessed, it is important that the method is validated against current methods. This validation is described below, in relation to FIGS. 3 and 4.

To evaluate the above-described approach, a 3-fold cross-validation was performed using a dataset consisting of 5,054 Haematoxylin and Eosin (H&E) stained colon biopsy WSIs from the University Hospitals Coventry and Warwickshire (UHCW), where each slide was labelled as either normal or abnormal. The results of this validation are illustrated in FIG. 3.

In FIG. 3, a receiver operating characteristic (AUC-ROC) curve is plotted on the left hand side. An average area under the AUC-ROC curve of 0.9783±0.0036 was observed. A precision-recall (AUC-PR) curve is plotted on the right hand side. An area under the AUC-PR curve of 0.9798±0.0031 was observed. The plots of FIG. 3 also include results obtained using the IDaRS method set out in Bilal, M., et al., Development and validation of a weakly supervised deep learning framework to predict the status of molecular pathways and key mutations in colorectal cancer from routine histology images: a retrospective study, The Lancet Digital Health 3, e763-e772 (2021), the CLAM method set out in Lu, M. Y., et al. Data-efficient and weakly supervised computational pathology on whole-slide images, Nature biomedical engineering 5, 555-570 (2021), and a random forest (RF) classifier.

It can be seen from FIG. 3 that the method of this application achieves the best performance when compared with these methods, i.e. a higher area is observed under both the AUC-ROC curve and the AUC-PR curve.

Since the method of this application is intended for screening, it must achieve high sensitivity. Therefore, assessment of the specificity at high sensitivity cut-off thresholds provides a good indication of its potential effectiveness as a screening tool. The specificity of the method of this application is plotted at different sensitivities in the middle plot of FIG. 3. Here it can be seen that this method sustains a good level of performance at various cut-offs. In particular, specificities of 0.8916±0.0176, 0.7865±0.0429 and 0.5409±0.1210 are produced for sensitivity cut-offs of 0.95, 0.97 and 0.99, respectively. Furthermore, these specificities are all higher than the specificities of the compared methods for each of these sensitivity cut-offs.

A true reflection of the method's clinical utility involves the assessment of its performance on completely unseen cohorts. For this, 3 additional H&E-stained colon biopsy datasets have been utilised, providing a total of 1,537 WSIs. Here, 1,132 slides were obtained from IMP Diagnostics Laboratory in Portugal, 148 slides from East Suffolk and North Essex (ESNE) NHS Foundation Trust, and 257 slides and South Warwickshire NHS Foundation Trust. Slides were again categorised as either normal or abnormal, and the results have been presented in FIG. 2 against the same methods used in FIG. 3, using the same metrics as were presented in FIG. 3.

It can be seen from FIG. 4 that the described method obtains a strong performance for both the ESNE and South Warwickshire cohorts, which is exemplified by areas under the AUC-ROC curves of 0.9567±0.0155 and 0.9649±0.0025 for ESNE and South Warwickshire respectively, and areas under the AUC-PR curves of 0.9731±0.0105 and 0.9466±0.0034 for ESNE and South Warwickshire respectively. For the IMP cohort, an area under the AUC-ROC curve of 0.9789±0.0023 is achieved, and area under the AUC-PR curve of 0.9949±0.0006 is achieved, indicating that the method described herein achieves the best performance for differentiating between normal and neoplastic WSIs.

It is important to note that there is a large difference in performance between the method described herein and other approaches on the external cohorts, signifying that superior generalisation to unseen data is a strength of the described method. In particular, at a sensitivity of 0.99, the method described herein obtains a percentage increase over IDaRS of 47.4%, 63.6% and 158.9% for the IMP, ESNE and South Warwickshire cohorts respectively. It is thought that a major reason for this is because of the ability of this method's multi-task segmentation model to perform well on data from different centres.

FIG. 5 illustrates the impact of the method described herein on clinical practice, illustrating the proportion of slides that require pathologist review to achieve a predetermined sensitivity. In these plots, a sensitivity of 0.99 is targeted (indicated by the black horizontal line towards the top of each plot). This is deemed reasonable due to high levels of inter-observer disagreement for conditions such as mild inflammation. A vertical dashed line is also included in each plot which shows the proportion of abnormal slides in each dataset, indicating the minimum number of slides that need to be reviewed for screening. For each of the datasets, it is observed that for the target of 0.99 sensitivity, the method described herein can screen out 32%, 31%, 17% and 13% of slides from the UHCW, South Warwickshire, ESNE and IMP datasets respectively. In contrast, the other methods that have been compared herein are able to screen out much lower percentages of slides, thus requiring greater work from pathologists to review the additional slides.

1. A computer-implemented method of analysing an image of a tissue specimen, wherein the method comprises:
detecting in the image each of a primary type of biological entity;
detecting in the image one or more secondary types of biological entity associated with each of the detected primary type of biological entities;
generating an entity graph, in which each of a plurality of graph nodes is assigned to a primary biological entity and associated with predictive features measured from the image in respect of that graph node, including at least one predictive feature that is measured relative to two or more types of biological entity;
inputting the entity graph into one or more machine learning algorithms to compute one or more predictions for the tissue specimen; and
outputting the one or more predictions.

2. The computer-implemented method of claim 1, wherein each of the graph nodes is assigned to a single biological entity of the primary type of biological entity.

3. The computer-implemented method of claim 1, wherein the primary type of biological entity is gland.

4. The computer-implemented method of claim 3, wherein the one or more secondary types of biological entity are nuclei or lumen within or around an associated gland.

5. The computer-implemented method of claim 4, wherein the at least one predictive feature is measured relative to two or more types of biological entity selected from glands, nuclei, and lumen.

6. The computer-implemented method of claim 1, wherein the entity graph comprises other nodes that represent respective biological entities detected, interconnected by edges representing interactions between entities represented by the other nodes.

7. The computer-implemented method of claim 1, wherein the predictive features are determined with respect to parts of the biological entities, including centroids and boundaries.

8. The computer-implemented method of claim 1, wherein the predictive features comprise one or more of a linear dimension of a biological entity, an area of a biological entity, a morphological measure of a biological entity, a count of a biological entity, a linear separation between biological entities, boundaries, or a combination thereof.

9. The computer-implemented method of claim 1, wherein the predictive features are a statistical measure of a plurality of measurements.

10. The computer-implemented method of claim 9, wherein the statistical measure relates to an average or a measure of variation.

11. The computer-implemented method of claim 1, wherein the predictive features comprise dimensions or areas of biological entities and the dimensions or areas are measured in pixels at a known distance per pixel.

12. The computer-implemented method of claim 1, wherein the predictive features comprise measurements that are normalised relative to a population of a relevant type of biological entity.

13. The computer-implemented method of claim 1, wherein the one or more machine learning algorithms includes a graph neural network.

14. The computer-implemented method of claim 13, wherein the entity graph comprises node vectors, xᵢ, which each represent a primary biological entity in terms of the predictive features associated with that primary biological entity, and the graph neural network aggregates information across other nodes using edges in its computation.

15. The computer-implemented method of claim 13, wherein the graph neural network comprises an aggregation step comprising updating each of the other node representation by aggregating information from its neighbours.

16. The computer-implemented method of claim 13, further comprising using a real-valued mask, which gives less weight to unimportant graph components, such that a subset of nodes and other predictive features are generated that play a greater role in a prediction of the graph neural network, and other nodes and other predictive features of the graph neural network that are of lesser importance are removed.

17. The computer-implemented method of claim 1, wherein the method comprises a node explanation mask and a feature explanation mask that are learned.

18. The computer-implemented method of claim 1, further comprising outputting an identification of biological entities or the graph nodes that contribute to the one or more predictions and an indication of a strength of a contribution to the one or more predictions.

19. The computer-implemented method of claim 18, wherein an output in respect of the biological entities or the graph nodes that contribute to the one or more predictions is presented as a heat map.

20. The computer-implemented method of claim 1, further comprising outputting an identification of one or more features for a particular biological entity of graph node that contribute to the one or more predictions and an indication of a strength of a contribution of the one or more features to the one or more predictions.

21. The computer-implemented method of claim 19, wherein the identification of the feature or features that contribute to the one or more predictions is displayed for one or more biological entities of graph nodes that most strongly contribute to the one or more predictions.

22. The computer-implemented method of claim 19, wherein the feature or features that are identified are accompanied by a description of a clinical relevance of the feature or features.

23. A data processing apparatus comprising memory having instructions stored thereon and one or more processors coupled to the memory and configured to execute the stored instructions to perform the method as claimed in claim 1.

24. A non-transitory computer-readable medium comprising instructions which, when executed by a computer, cause the computer to carry out the method as claimed in claim 1.

25. (canceled)
